(19) United States
(12) Patent Application Publication
(10) Pub. No.: US 2019/0087464 A1
(43) Pub. Date: Mar. 21, 2019

(54) REGIONAL POPULATION MANAGEMENT SYSTEM AND METHOD

(71) Applicant: HONGFUJIN PRECISION ELECTRONICS (TIANJIN) CO.,LTD., Tianjin (CN)

(72) Inventor: SHIH-CHENG WANG, New Taipei (TW)

(21) Appl. No.: 15/802,464

(22) Filed: Nov. 3, 2017

(30) Foreign Application Priority Data
Sep. 21, 2017 (CN) 201710861584.5

(51) Int. Cl. G06F 17/30; G06K 9/00; H04W 4/02; G06F 21/31

(52) U.S. Cl. CPC G06F 17/30528; G06K 9/00295; G06F 17/30516; G06F 21/31; G06K 9/00369; H04W 4/022

(57) ABSTRACT

A system for recording, analyzing, and managing persons who enter and leave one or more areas includes a plurality of modules. A setting module sets an entrance guard authorization to each entering-exiting person (E-E person) of an area. An obtaining module obtains entrance guard entrance-exit information and video record information of a first E-E person. An access control module determines whether the first E-E person is authorized according to card swiping information and image recognition information and opens a current entrance guard when the first E-E person is authorized. An information processing module generates an entrance-exit list of the first E-E person according to the entrance guard entrance-exit information and the video record information. A regional population management method is also provided.

### FIELD

The subject matter herein generally relates to systems and methods for population analysis.

### BACKGROUND

A number of foreigners or travelling workers may be more than a number of native population in a highly popular city. It is difficult to keep track of the movement of a floating population and manage the regional population of the community.

### BRIEF DESCRIPTION OF THE DRAWINGS

Implementations of the present technology will now be described, by way of example only, with reference to the attached figures.

FIG. 1 is a block diagram of an embodiment of a regional population management system.

FIG. 2 is a block diagram of an embodiment of multiple servers applied in the regional population management system of FIG. 1.

FIG. 3 is a block diagram of an embodiment of the regional population management system of FIG. 1.

FIG. 4 is a block diagram of another embodiment of the regional population management system of FIG. 1.

FIG. 5 is a flowchart of an embodiment of a proprietor adding residence information of a tenant through a residence management application.

FIG. 6 is a flowchart of an embodiment of a regional population management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The connection can be such that the objects are permanently connected or releasably connected. The term “comprising,” when utilized, means “including, but not necessarily limited to”; it specifically indicates open-ended inclusion or membership in the so-described combination, group, series, and the like.

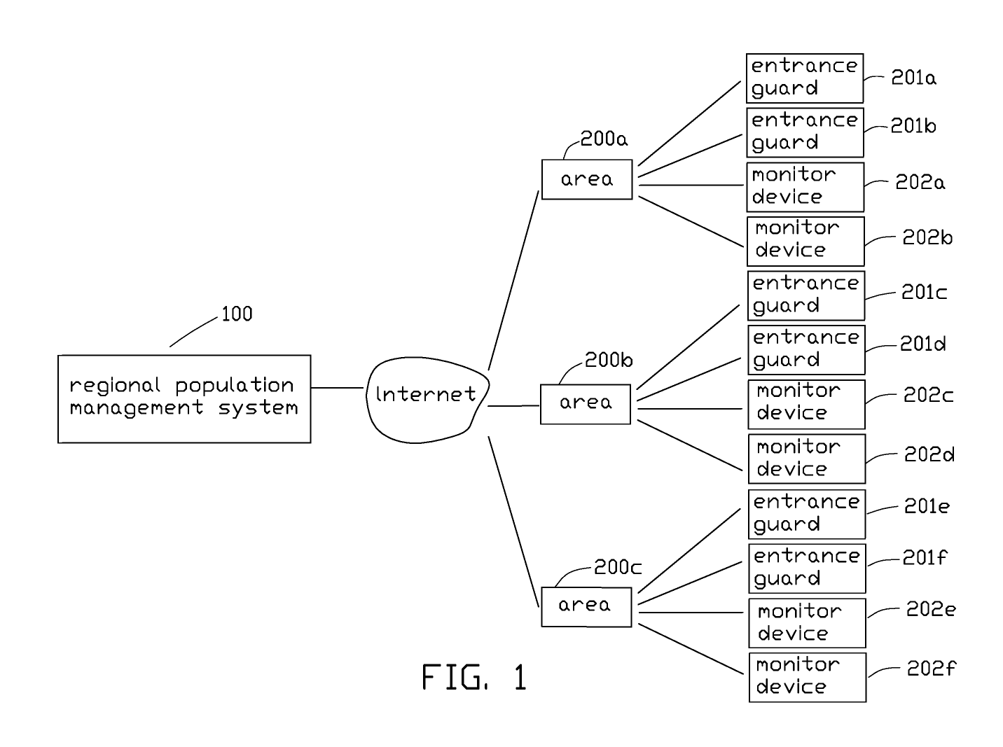

FIG. 1 illustrates a regional population management system 100 in accordance with an embodiment.

The regional population management system 100 is configured to manage a plurality of areas and obtain entrance-exit information of people in the plurality of areas through the internet. The regional population management system 100 can obtain migration movement information of the plurality of areas. The regional population management system 100 can further offer an integrated security solution from videos monitoring to access controls, intrusion detections, and closed circuit television systems (CCTVs). The plurality of areas can comprise three areas 200a, 200b, and 200c, for example. Each of the areas 200a, 200b, and 200c can be a community or a street for example.

Each of the areas 200a, 200b, and 200c comprises a plurality of entrance guards and a plurality of monitoring devices. The plurality of entrance guards can comprise six entrance guards, 201a to 201f, for example. The plurality of monitoring devices can comprise six monitoring devices, 202a to 202f, for example.

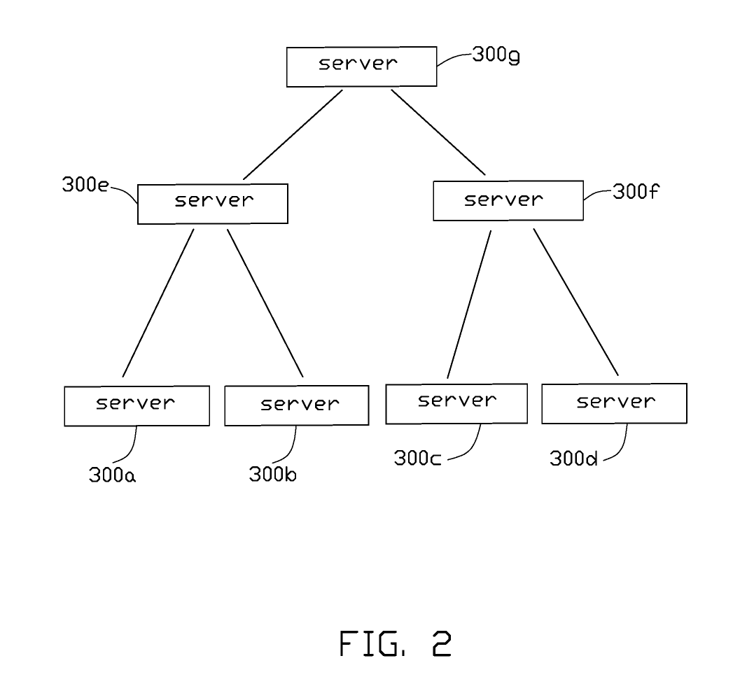

Referring to FIG. 2, the regional population management system 100 can comprise a plurality of servers to process and store gathered data. The plurality of servers can comprise seven servers, 300a to 300g, for example. The servers, 300a to 300g, can be divided into three layers. For example, a city A1 comprises a plurality of streets A2 and each of the plurality of streets A2 also comprises a plurality of communities A3. The servers 300a, 300b, 300c, and 300d correspond to the plurality of communities A3, the servers 300e and 300f correspond to the plurality of streets A2, and the server 300g corresponds to the city A1.

In one embodiment, the servers 300a and 300b can communicate with the server 300e, the servers 300c and 300d can communicate with the server 300f, and the servers 300e and 300f can communicate with the server 300g.

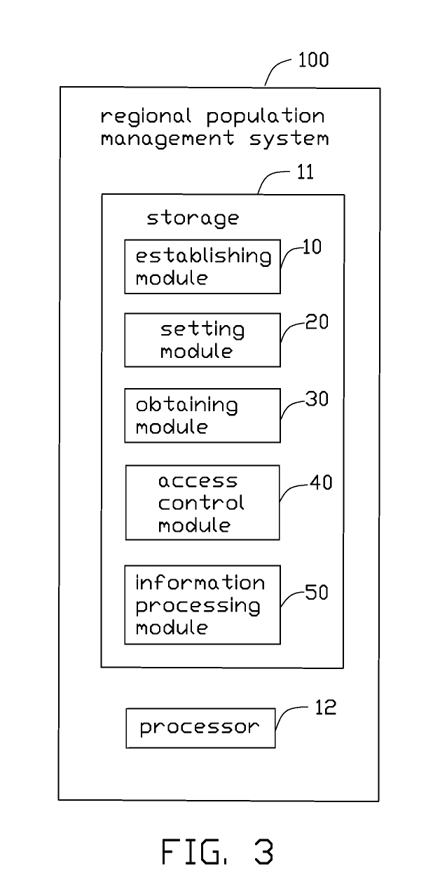

Referring to FIG. 3, the regional population management system 100 is configured to manage the area 200a, and the server 300a is configured to process and store the gathered data of the area 200a. The area 200a comprises the plurality of entrance guards 201a and 201b (as shown in FIG. 1) and the plurality of monitoring devices 202a and 202b (as shown in FIG. 1) for example.

The regional population management system 100 can comprise at least one storage 11 and at least one processor 12. The regional population management system 100 can further comprise a plurality of modules, such as an establishing module 10, a setting module 20, an obtaining module 30, an access control module 40, and an information processing module 50. The modules 10-50 can comprise one or more software programs in the form of computerized codes stored in the storage 11. The computerized codes can include instructions that can be executed by the processor 12 to provide functions for the modules 10-50.

The establishing module 10 is configured to obtain identity information of entrance-exit persons of the area 200a. The establishing module 10 is further configured to establish an identity database corresponding to each of the entrance-exit persons according to obtained identity information.

In one embodiment, the entrance-exit persons can enter and leave the area 200a.

In one embodiment, the entrance-exit persons can comprise tenants, proprietors, property managers, and community policemen. The identity information can comprise identity card information, facial information, home address information, phone number, and education level information.

In one embodiment, the establishing module 10 is further configured to check the obtained identity information of each of the entrance-exit persons through a real-name authentication system and/or a public security organ criminal record system. Then, the establishing module 10 can find out false identity information or criminal record information.

In one embodiment, the establishing module 10 is further configured to upload the identity database of each of the entrance-exit persons to a residence information registration platform. Then, the government sector can obtain the residence information of the area residents in real time.

The setting module 20 is configured to set an entrance guard authorization to each of the entrance-exit persons according to the identity information and current residence information. For example, a tenants and a property manager have different entrance guard authorities.

In one embodiment, the entrance guards 201a and 201b can comprise community entrance guards, building entrance guards, and elevator entrance guards.

The obtaining module 30 is configured to obtain entrance guard entrance-exit information and video record information of a first entrance-exit person of the area 200a. The entrance guard entrance-exit information can be entrance-exit information when the first entrance-exit person enters and leaves the entrance guards 201a and 201b of the area 200a. The entrance guard entrance-exit information can comprise card swiping information and image recognition information.

In one embodiment, the card swiping information can be identity card information, residence card information, or entrance guard card information. The image recognition information can be face recognition information or retina recognition information. The plurality of monitoring devices 202a and 202b (as shown in FIG. 1) in the area 200a can be surveillance cameras. The surveillance cameras can be located in each building of the area 200a and along a road of the area 200a. Each entrance guard and each monitoring device has a unique number.

The access control module 40 is configured to determine whether the first entrance-exit person is authorized according to the card swiping information and the image recognition information. When the access control module 40 determines that the first entrance-exit person is authorized, the access control module 40 opens a current entrance guard to allow the first entrance-exit person to get through. When the access control module 40 determines that the first entrance-exit person is not authorized, the access control module 40 does not open the current entrance guard.

In one embodiment, when the card swiping information and the image recognition information are matched successfully, the access control module 40 determines that the first entrance-exit person is authorized. When the card swiping information and the image recognition information are not matched, the access control module 40 determines that the first entrance-exit person is not authorized.

In one embodiment, when a total number of successful matches of the card swiping information and the image recognition information is greater than a predetermined value (e.g. 50 times), the first entrance-exit person can be upgraded in authority. The access control module 40 determines that the first entrance-exit person can be authorized only by the image recognition information (no card swiping information is required).

In one embodiment, the entrance guards 201a and 201b and the monitoring devices 202a and 202b can communicate with the server 300a through a wireless network (e.g. 4G network, WIFI network). Then, the server 300a can obtain, store, and process the entrance-exit information and the video record information of the first entrance-exit person in real time.

The information processing module 50 is configured to generate an entrance-exit list of the first entrance-exit person according to the entrance guard entrance-exit information and the video record information. For example, the information processing module 50 generates a first entrance-exit list corresponding to the first entrance-exit person, a second entrance-exit list corresponding to a second entrance-exit person, and a third entrance-exit list corresponding to a third entrance-exit person.

In one embodiment, the entrance-exit list can comprise entrance guard swiping time, entrance guard numbers, capturing images during image recognition, and entrance-exit video.

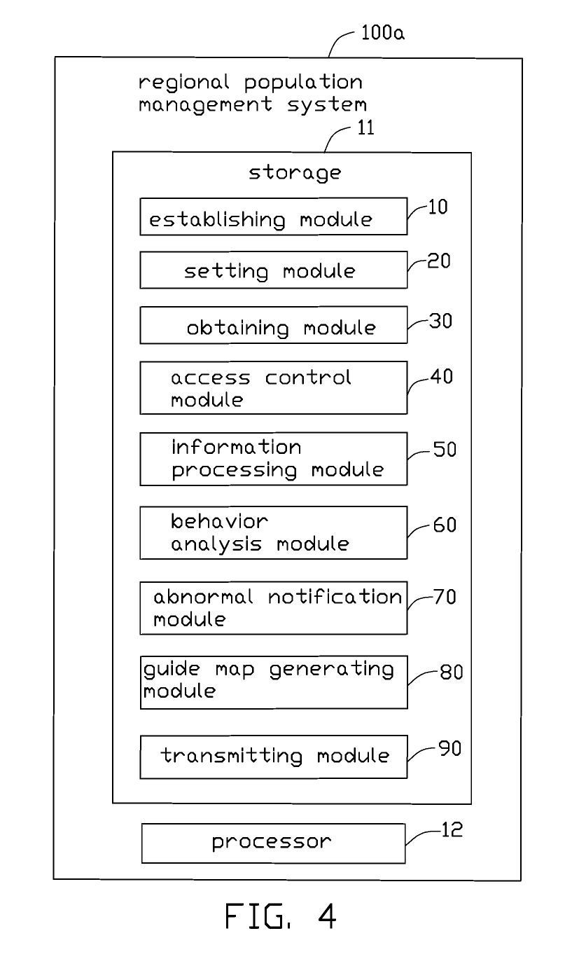

Referring to FIG. 4, a regional population management system 100a is similar to the regional population management system 100 of FIG. 3. The regional population management system 100a further comprises a behavior analysis module 60, an abnormal notification module 70, a guide map generating module 80, and a transmitting module 90.

The behavior analysis module 60 is configured to obtain an entrance-exit tracking of the first entrance-exit person according to the entrance guard entrance-exit information and the video record information. The behavior analysis module 60 can use a big data analysis algorithm to analyze an entrance-exit behavior of the first entrance-exit person according to the entrance-exit tracking.

The abnormal notification module 70 is configured to determine whether an entrance-exit behavior of the first entrance-exit person is abnormal according to the entrance guard entrance-exit information and the video record information. When abnormal notification module 70 determines that the first entrance-exit person has the abnormal entrance-exit behavior, the abnormal notification module 70 outputs an alarm.

In one embodiment, the abnormal entrance-exit behavior can be multiple times of abnormal card swiping or multiple times that the card swiping information does not match the image recognition information.

In one embodiment, the abnormal notification module 70 can output the alarm to warn the property managers of the area 200a.

In one embodiment, the abnormal notification module 70 is further configured to obtain operation states of the entrance guards 201a and 201b and the monitoring devices 202a and 202b. When the abnormal notification module 70 determines that one of the entrance guards 201a and 201b or the monitoring devices 202a and 202b is in a abnormal state, the abnormal notification module 70 can output the alarm to warn the property manager.

The guide map generating module 80 is configured to obtain location information and serial number information of the plurality of entrance guards 201a and 201b and the plurality of monitoring devices 202a and 202b. The guide map generating module 80 combines a current map, the location information, and the serial number information of the plurality of entrance guards 201a and 201b and the plurality of monitoring devices 202a and 202b to generate a monitoring map. In the monitoring map, the entrance guards 201a and 201b and the monitoring devices 202a and 202b are shown as device icons. By clicking a device icon of the monitoring map, a user can view gathering information, operation state information, and maintaining information of the device (e.g. entrance guard or monitoring device).

The transmitting module 90 is configured to send predetermined notification information to each of the entrance-exit persons according to the identity libraries of the entrance-exit persons. For example, the transmitting module 90 can obtain a phone number of each entrance-exit person and send predetermined notification information to each entrance-exit person according to the phone number.

In one embodiment, the predetermined notification information can be community information, police information, or advertising, etc.

In one embodiment, the entrance-exit persons comprise different roles (tenants, proprietors, property managers, and community policeman), the regional population management system 100 can offer different service functions according to each role. The establishing module 10 is further configured to establish a tree topology diagram among the different roles. The setting module 20 is further configured to set an operation authority to each of the roles.

For example, the regional population management system 100 can offer first service functions to a tenant, such as paying water and electricity fee online, paying rent online, and making enquiry as to one's own identity database, etc. The regional population management system 100 can offer second service functions to a property manager, such as, inquiring as to entrance guard entrance-exit information or video record information, sending community information, etc. The regional population management system 100 can offer third service functions to a community policeman, such as managing residence information, sending police information, checking identity information, etc.

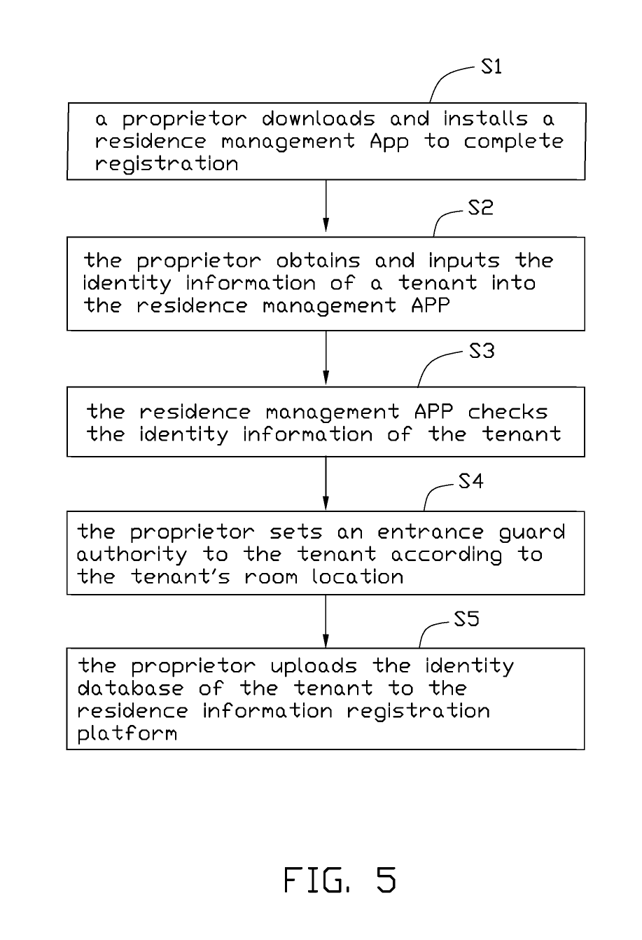

FIG. 5 illustrates one embodiment of a proprietor B2 adding residence information of a tenant B1. In a first step S1, the proprietor B2 downloads and installs a residence management application (APP) to complete registration. In a second step S2, the proprietor B2 obtains and inputs the identity information (e.g. identity card information, facial information, home address information, phone number, and education level information) of the tenant B1 into the residence management APP. In a third step S3, the residence management APP checks the identity information of the tenant B1. In a fourth step S4, after the residence management APP can find no abnormalities, the proprietor B2 sets an entrance guard authorization to the tenant B1 according to the tenant's room location. In a fifth step S5, the proprietor B2 uploads the identity database of the tenant B1 to the residence information registration platform.

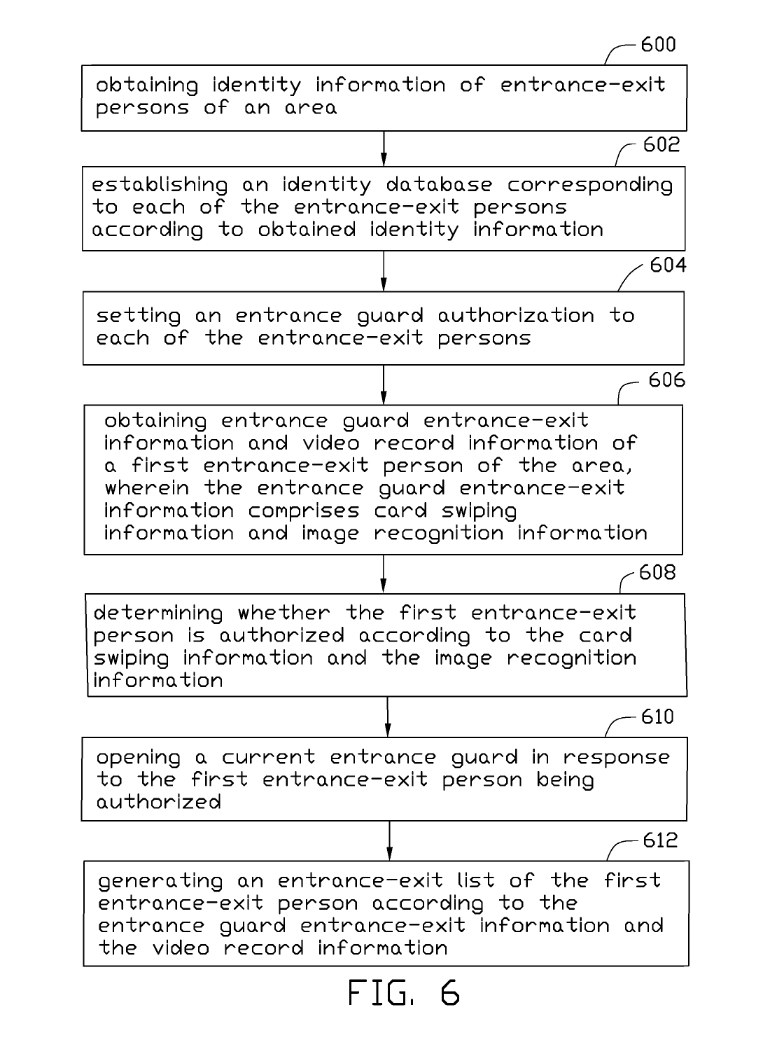

FIG. 6 illustrates one embodiment of a regional population management method. The flowchart presents an embodiment of the method. The exemplary method is provided by way of example, as there are a variety of ways to carry out the method. The method described below can be carried out using the configurations illustrated in FIGS. 3-4, for example, and various elements of these figures are referenced in explaining the example method. Each step shown in FIG. 6 may represent one or more processes, methods, or subroutines, carried out in the example method. Furthermore, the illustrated order of steps is illustrative only and the order of the steps can change. Additional steps can be added or fewer steps may be utilized, without departing from this disclosure. The example method can begin at step 600.

In step 600, the establishing module 10 obtains identity information of entrance-exit persons of the area 200a.

In step 602, the establishing module 10 establishes an identity database corresponding to each of the entrance-exit persons according to obtained identity information.

In step 604, the setting module 20 sets an entrance guard authorization to each of the entrance-exit persons.

In step 606, the obtaining module 30 obtains entrance guard entrance-exit information and video record information of a first entrance-exit person of the area 200a. The entrance guard entrance-exit information can comprise card swiping information and image recognition information.

In step 608, the access control module 40 determines whether the first entrance-exit person is authorized according to the card swiping information and the image recognition information.

In step 610, when the access control module 40 determines that the first entrance-exit person is authorized, the access control module 40 opens a current entrance guard to allow the first entrance-exit person to get through.

In step 612, the information processing module 50 generates an entrance-exit list of the first entrance-exit person according to the entrance guard entrance-exit information and the video record information.

The embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A regional population management method, comprising:
obtaining identity information of entrance-exit persons of an area;
establishing an identity database corresponding to each of the entrance-exit persons according to obtained identity information, wherein the area comprises a plurality of entrance guards and a plurality of monitoring devices;
setting an entrance guard authorization to each of the entrance-exit persons;
obtaining entrance guard entrance-exit information and video record information of a first entrance-exit person of the area, wherein the entrance guard entrance-exit information comprises card swiping information and image recognition information;
determining whether the first entrance-exit person is authorized according to the card swiping information and the image recognition information;
opening a current entrance guard in response to the first entrance-exit person being authorized; and
generating an entrance-exit list of the first entrance-exit person according to the entrance guard entrance-exit information and the video record information.

2. The method of claim 1, wherein obtaining the identity information of entrance-exit persons of the area comprises:
obtaining the identity information of entrance-exit persons of the area; and
checking the identity information of each of the entrance-exit persons through a real-name authentication system.

3. The method of claim 2, further comprising:
uploading the identity database of each of the entrance-exit persons to a residence information registration platform.

4. The method of claim 1, further comprising:
obtaining an entrance-exit tracking of the first entrance-exit person according to the entrance guard entrance-exit information and the video record information; and
analyzing an entrance-exit behavior of the first entrance-exit person according to the entrance-exit tracking.

5. The method of claim 1, further comprising:
determining whether an abnormal entrance-exit behavior of the first entrance-exit person is existed according to the entrance guard entrance-exit information and the video record information; and
outputting an alarm in response to the abnormal entrance-exit behavior of the first entrance-exit person being existed.

6. The method of claim 1, further comprising:
obtaining location information and serial number information of the plurality of entrance guards and the plurality of monitoring devices; and
generating a monitoring map according to the location information and the serial number information of the plurality of entrance guards and the plurality of monitoring devices.

7. The method of claim 6, further comprising:
clicking a device icon of the monitoring map to view gathering information, operation state information, and maintaining information of the device; and
wherein the device can be the entrance guard or the monitoring device.

8. The method of claim 1, wherein the entrance-exit persons comprise different roles, the regional population management method further comprises:
establishing a tree topology diagram among the different roles; and
setting an entrance-exit authority and an operation authority to each of the roles.

9. The method of claim 1, further comprising:
sending predetermined notification information to each of the entrance-exit persons according to the identity libraries of the entrance-exit persons.

10. A regional population management system for managing entrance-exit persons of an area, the area comprising a plurality of entrance guards and a plurality of monitoring devices, the regional population management system comprising:
at least one processor;
a storage; and
one or more programs that are stored in the storage unit and executed by the at least one processor, the one or more programs comprising instructions for:
obtaining identity information of the entrance-exit persons of the area;
establishing an identity database corresponding to each of the entrance-exit persons according to obtained identity information;
setting an entrance guard authorization to each of the entrance-exit persons;
obtaining entrance guard entrance-exit information and video record information of a first entrance-exit person of the area, wherein the entrance guard entrance-exit information comprises card swiping information and image recognition information;
determining whether the first entrance-exit person is authorized according to the card swiping information and the image recognition information;
opening a current entrance guard in response to the first entrance-exit person being authorized; and
generating an entrance-exit list of the first entrance-exit person according to the entrance guard entrance-exit information and the video record information.

11. The system of claim 10, wherein obtaining the identity information of entrance-exit persons of the area comprises:
obtaining the identity information of entrance-exit persons of the area; and
checking the identity information of each of the entrance-exit persons through a real-name authentication system.

12. The system of claim 11, wherein the one or more programs further comprise:
uploading the identity database of each of the entrance-exit persons to a residence information registration platform.

13. The system of claim 10, wherein the one or more programs further comprise:
obtaining an entrance-exit tracking of the first entrance-exit person according to the entrance guard entrance-exit information and the video record information; and
analyzing an entrance-exit behavior of the first entrance-exit person according to the entrance-exit tracking.

14. The system of claim 10, wherein the one or more programs further comprise:
determining whether an abnormal entrance-exit behavior of the first entrance-exit person is existed according to the entrance guard entrance-exit information and the video record information; and
outputting an alarm in response to the abnormal entrance-exit behavior of the first entrance-exit person being existed.

15. The system of claim 10, wherein the one or more programs further comprise:
obtaining location information and serial number information of the plurality of entrance guards and the plurality of monitoring devices; and
generating a monitoring map according to the location information and the serial number information of the plurality of entrance guards and the plurality of monitoring devices.

16. The system of claim 15, wherein the one or more programs further comprise:
clicking a device icon of the monitoring map to view gathering information, operation state information, and maintaining information of the device; and
wherein the device can be the entrance guard or the monitoring device.

17. The system of claim 10, wherein the entrance-exit persons comprise different roles, the regional population management method further comprises:
establishing a tree topology diagram among the different roles; and
setting an entrance-exit authority and an operation authority to each of the roles.

18. The system of claim 10, wherein the one or more programs further comprise:
sending predetermined notification information to each of the entrance-exit persons according to the identity libraries of the entrance-exit persons.
